(19) United States
(12) Patent Application Publication
(10) Pub. No.: US 2015/0158968 A1
(43) Pub. Date: Jun. 11, 2015

(54) PRODUCTION OF LOW-EMISSION FLEXIBLE POLYURETHANE FOAMS

(71) Applicant: EVONIK INDUSTRIES AG, Essen (DE)

(72) Inventors: Sarah Schmitz, Duisburg (DE); Roland Hubel, Essen (DE)

(73) Assignee: EVONIK INDUSTRIES AG, Essen (DE)

(21) Appl. No.: 14/413,909

(22) PCT Filed: Jun. 12, 2013
(86) PCT No.: PCT/EP2013/062099

§ 371 Date: Jan. 9, 2015

(30) Foreign Application Priority Data
Jul. 11, 2012 (DE) 10 2012 212 077.7

(51) Int. Cl. C08G 18/24; C08G 18/32; C08G 18/08; C08G 18/76

(52) U.S. Cl. CPC C08G 18/244; C08G 18/7621; C08G 18/3206; C08G 18/14; C08G 2101/0008

(57) ABSTRACT

The present invention relates to compositions containing at least one metal salt of a carboxylic acid and one or more amines of formula (I)

R⁴R¹₂N—(CH₂)ₓ—N(R³)—(CH₂)_{y}—NR¹R² (I)

where R¹=a hydrocarbon radical of 1 to 10 carbon atoms, and the same or different in each occurrence, R², R³ and R⁴ are each R¹ or a —(Z)_{z}—OH radical and the same or different in each occurrence, where Z is CH₂ or CHR′ where R′=hydrocarbon radical of 1 to 10 carbon atoms, and the same or different in each occurrence, z=1 to 10, x=1 to 10, y=1 to 10, and with the proviso that at least one of R², R³ and R⁴ is a —(Z)_{z}—OH radical, to a process for producing polyurethane foams wherein compositions of this type or at least one metal salt of a carboxylic acid and one or more amines of formula (I) are used, and also to low-emission polyurethane foams obtained using a carboxylic acid/a metal salt thereof and one or more amines of formula (I).

The present invention relates to compositions containing at least one metal salt of a carboxylic acid and one or more amines of formula (I) as defined hereinbelow, to a process for producing polyurethane foams wherein compositions of this type or at least one metal salt of a carboxylic acid and one or more amines of formula (I) are used, and also to low-emission polyurethane foams obtained using a carboxylic acid/a metal salt thereof and one or more amines of formula (I).

Flexible polyurethane (PU) foams are used in a multiplicity of technical applications in industry and the home, for example for sound damping, for production of mattresses or for upholstery of furniture. The automotive industry is a particularly important market for the various types of PU foams, such as conventional flexible foams based on an ether polyol or an ester polyol, cold-cure foams (frequently also known as high-resilience (HR) foam) and rigid foams, as well as foams with properties between these classifications.

Flexible polyurethane foams are typically produced by reacting di- or polyisocyanates with compounds containing two or more isocyanate-reactive hydrogen atoms, in the presence of blowing agents and customary auxiliary and adjunct materials. The catalysts used are frequently metal salts of carboxylic acids, for example tin(II) or bismuth(II) salts of 2-ethylhexanoic acid, and/or amines.

Disadvantageously, the ready-produced polyurethane foams frequently emit volatile organic compounds. These VOC emissions constitute a massive quality defect for many fields of use, for example in the automotive industry. Emissions, for example 2-ethylhexanoic acid, constitute a massive quality defect or are even harmful when maximum limits are exceeded in furniture and mattresses in particular.

Volatile catalysts and/or impurities therein constitute a significant source of emissions from foamed materials. Volatile amine catalysts or else metal catalyst ligands must be mentioned here in particular, one example being the carboxylic acid from the catalyst, e.g. 2-ethylhexanoic acid.

The use of the common metal catalyst tin octoate, which decomposes into tin oxide and 2-ethylhexanoic acid during foaming, results in a significant emission of 2-ethylhexanoic acid being observed. Tin ricinoleate might be a low-emission alternative here. However, compared with the usual tin octoate, the low-emission alternative of tin ricinoleate has to be used in a two to three times higher amount to generate the same catalytic activity.

To avoid emissions from foamed materials due to the amine catalyst used, prior artisans have used, for example, reactive amine catalysts which become bound within the polyurethane foam by chemical bonding, so that the amine catalyst does not lead to emissions.

US 2003088046 describes amine catalysts of this type for production of polyurethane resins. In particular is the use of a catalyst (D) which has to contain two amine compounds: an imidazole compound and a tertiary amine catalyst with a reactive group, for example N-(2-hydroxyethyl)-N,N′,N″,N″-tetramethyldiethylenetriamine, is described. According to [0048] the sole use of tertiary amine catalysts having a reactive group leads to poor results. The use of metal catalysts in combination with the amine catalysts is described as possible but not as preferable. There are no examples of using the combination of amine and metal catalysts.

JP 2008-074903 (PAJ) describes a process for producing polyurethane resins giving a low emission of amine. The catalysts used are mixtures of two or more amines wherein at least one amine has two or more OH groups and at least one amine was obtained, for example, by the reaction of a diethylene ether or bis(aminoethyl) ether with propylene oxide or ethylene oxide and subsequent reductive methylation.

I. S. Bechara and F. P. Carroll, in Journal of Cellular Plastics, March/April 1980, Technomic Publishing Corp, pages 89 to 101, describe unusual catalysts for the production of flexible PU foams. They conducted comparative investigations of hydroxyl-containing amines, and these show that compounds of this type that have primary hydroxyl groups are preferable over those having secondary or tertiary hydroxyl groups. They also conducted tests wherein a tin catalyst was used together with trimethylhydroxyethylethylenediamine/triethylenediamine and 2-[[2-(dimethylamino)ethyl]methylamino]ethanol (DABCO® TL from Air Products).

There continues to be a need for recipes to produce low-emission PU foams that avoid one or more of the disadvantages mentioned above.

The problem addressed by the present invention was accordingly that of providing a polyurethane system which overcomes the described disadvantages of the prior art.

It was found that, surprisingly, the use of specific amines provides for dramatic reductions in emissions, especially the combined emissions of carboxylic acids and amine.

The present invention accordingly provides for the use of amines of formula (I) as defined hereinbelow, as acid scavengers in/for production of polyurethane foams, preferably flexible polyurethane foams.

The present invention also provides a composition suitable for production of polyurethane systems, containing one or more amines conforming to formula (I), one or more metal salts of carboxylic acids, water and optional additives selected from foam stabilizers, cell openers and nucleators, especially one or more polyoxyalkylene-polysiloxane copolymers as foam stabilizers.

The present invention more particularly provides a polyurethane foam as described in the claims which has a low amine and carboxylic acid evolution.

The present invention has the advantage that the polyurethane systems, especially polyurethane foams and preferably flexible polyurethane foams, obtained using the amines conforming to formula (I) have significantly reduced, if any, emissions, especially acid emissions, compared with polyurethane systems utilizing conventional amines or other reactive amines.

Using the amine of formula (I) in the manner of the present invention gives a significant reduction in the emission of organic acid in flexible polyurethane foam.

It is particularly advantageous that the (flexible) polyurethane foams obtained using the amines of formula (I) are low-emission with regard to the amine and metal catalysts used. It is more particularly advantageous that the emissions from the polyurethane systems, especially flexible polyurethane foams, obtained using the amines of formula (I) are acid-free, especially free of 2-ethylhexanoic acid (EHA) or are low in acid, especially low in EHA.

“Low-emission” with regard to 2-ethylhexanoic acid (EHA) is to be understood as meaning for the purposes of the present invention that the flexible polyurethane foam has an EHA emission of ≧0 μg/m³ and ≦5 μg/m³, preferably ≦1 μg/m³ and more preferably ≦0.1 μg/m³, as determined by the DIN 13419-1 test chamber method, 24 hours after test chamber loading.

“Low-emission” with regard to amine catalysts used is to be understood as meaning for the purposes of the present invention that the flexible polyurethane foam has an amine emission of ≧0 μg/g to ≦20 μg/g, preferably ≦10 μg/g and more preferably 5 μg/g, corresponding to the Daimler-Chrysler test method BP VWT709 VOC determination, 30 minutes at 90° C.

A very particular advantage of the amine of formula (I) over structurally similarly constructed, reactive substances is that it is an incorporable low-emission amine which has comparable catalytic activity in relation to polyurethane formation, yet at the same time prevents/reduces the emission of 2-EHA.

Yet, despite the reduction in or avoidance of emissions, especially acid emissions, using the amines of formula (I) results in little if any reduction in catalytic activity.

Using the amines of formula (I) in the manner of the present invention does not lead to any observable (significant) deterioration in foam properties.

Using the amines of formula (I) in the manner of the present invention makes it possible to produce flexible polyurethane foams using tin octoate which contains 2-ethylhexanoic acid as ligand without the resulting foams emitting 2-ethylhexanoic acid in significant concentrations.

If using, for example, the amine of formula (I) N,N,N,N-tetramethyl-N-hydroxyethyl-diethylenetriamine (THDTA) instead of pentamethyldiethylenetriamine (PMDETA) for production of flexible polyurethane foams, then the resulting foams are notable for a distinctly lower emission of both the amine and the acid. While the use of THDTA gives a flexible polyurethane foam which, after a 90-minute period at 120° C., gives virtually no acid or amine emission and hence an extremely low overall emission, the flexible polyurethane foam from PMDETA or other reactive amines gives emissions up to above 1000 μg/g.

The decisive advantage of THDTA and mixtures thereof with other amines over all other amines is accordingly that THDTA is an incorporable low-emission amine capable of binding the organic acids of the metal catalyst in a form such that emission can no longer emanate therefrom.

Using the amines of formula (I) in the manner of the present invention for production of flexible polyurethane foams provides flexible polyurethane foams despite the use of a tin octoate catalyst that pass the so-called Eco-Tests. 2-Ethylhexanoic acid and its tin salts are labelled H361d and hence are reprotoxicologically concerning because they are very likely to have a teratogenic effect on the unborn child. Any significant emission of salt or acid must therefore be avoided.

### BRIEF DESCRIPTION OF THE DRAWINGS

FIG. 1 is a graph of VOC emissions for various amine catalysts as described in Example 3 and as reported in Table 9 of the present application.

The present invention will now be described by way of example without any intention to restrict the invention to these exemplary embodiments. Where ranges, general formulae or classes of compounds are indicated in what follows, they shall encompass not just the corresponding ranges or groups of compounds that are explicitly mentioned, but also all sub-ranges and sub-groups of compounds which are obtainable by extraction of individual values (ranges) or compounds. Where documents are cited in the context of the present description, their content shall fully form part of the disclosure content of the present invention. Percentages are by weight, unless otherwise stated. Averages reported hereinbelow are weight averages, unless otherwise stated. Unless otherwise stated, the molar mass of compounds used was determined by gel permeation chromatography (GPC) and the structure determination of compounds used was by NMR methods, especially by ¹³C and ¹H NMR. All the measurements were carried out at 23° C. and ambient pressure (atmospheric pressure) unless otherwise stated. GC(/MS) methods described in the examples were used to determine the amines/emissions.

The compositions of the present invention are notable in that they contain at least one metal salt of a carboxylic acid and one or more amines of formula (I)

R⁴R¹₂N—(CH₂)ₓ—N(R³)—(CH₂)_{y}—NR¹R² (I)

where R¹=a hydrocarbon radical of 1 to 10 carbon atoms, preferably 1 to 3 carbon atoms and more preferably methyl, and the same or different in each occurrence,

R², R³ and R⁴ are each R¹ or a (Z)_{z}—OH radical where z=1 to 10, preferably 2 or 4, more preferably 2, and the same or different in each occurrence,

Z is CH₂ or CHR′ where R′=hydrocarbon radical of 1 to 10 carbon atoms, preferably alkyl or aryl, more preferably of 1 to 8 carbon atoms, preferably methyl or phenyl, and even more preferably methyl, and the same or different in each occurrence,

x=1 to 10, preferably 2 or 4, more preferably 2,

Y=1 to 10, preferably 2 or 4, more preferably 2,

with the proviso that at least one of R², R³ and R⁴ is a —(Z)_{z}—OH radical.

Preferably, per molecule of formula (I), only one of R², R³ and R⁴ is a —(Z)_{z}—OH radical, preferably with z=2 and all Z═CH₂ or one Z═CH₂ and the other Z═CH(CH₃). The remaining R², R³ and R⁴ are each an R¹ radical, preferably methyl.

It is particularly preferable for the composition of the present invention to contain as amine of formula (I) the hereinbelow recited amines of formulae (IIa) [N-(2-hydroxyethyl)-N,N′,N″,N″-tetramethyldiethylenetriamine] and/or (IIb) [N′-(2-hydroxyethyl)-N,N,N″,N″-tetramethyldiethylenetriamine] or of formulae (IIc1) [N-(2-hydroxypropyl)-N,N′,N″,N″-tetramethyldiethylenetriamine] and/or (IIc2) [N-(2-hydroxypropyl)-N,N′,N″,N″-tetramethyldiethylenetriamine] and/or (IId1) [N′-(2-hydroxypropyl)-N,N,N″,N″-tetramethyldiethylenetriamine] and/or (IIc2) [N′-(2-hydroxypropyl)-N,N,N″,N″-tetramethyldiethylenetriamine], preferably amines of formulae (IIa) [N-(2-hydroxyethyl)-N,N′,N″,N″-tetramethyldiethylenetriamine] and/or (IIb) [N′-(2-hydroxyethyl)-N,N,N″,N″-tetramethyldiethylenetriamine]

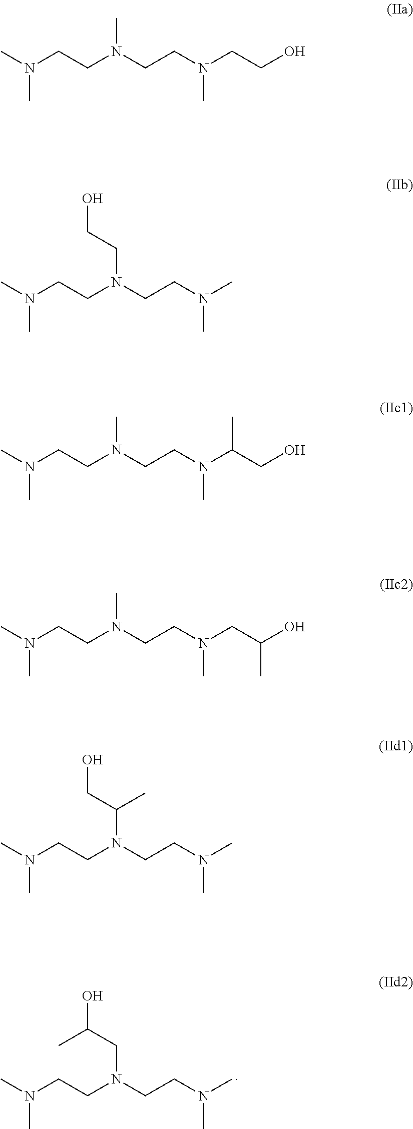

It is very particularly preferable for a mixture of amines of formulae (IIa) and (IIb) or of amines of formulae (IIc1), (IIc2), (IId1) and (IId2) to be present as amine of formula (I).

When the composition of the present invention comprises a mixture of amines of formulae (IIa) and (IIb), the molar ratio of amines of formula (IIa) to amines of formula (IIb) is in the range from 1:99 to 99:1 and preferably from 3:1 to 1:3.

When the composition of the present invention comprises a mixture of amines of formulae (IIc1), (IIc2), (IId1) and (IId2), the molar ratio of total amines of formulae (IIc1) and (IIc2) to total amines of formulae (IId1) and (IId2) is in the range from 1:99 to 99:1 and preferably from 3:1 to 1:3.

The amines of formula (I) preferably have the empirical formula C₁₀N₃OH₂₅.

In addition to amines of formula (I), the composition according to the present invention may further include amines that do not conform to formula (I). These further amines are more particularly useful as catalysts in the production of polyurethane foams, i.e. they catalyze the gel reaction (isocyanate-polyol), the blowing reaction (isocyanate-water) and/or the di- or trimerization of isocyanate.

Amines that do not conform to formula (I) are preferably selected from triethylamine, dimethylcyclohexylamine, tetramethylethylenediamine, tetramethylhexanediamine, pentamethyldiethylenetriamine, pentamethyldipropylenetriamine, triethylenediamine, dimethylpiperazine, 1,2-dimethylimidazole, N,N-dimethylhexadecylamine, silamorpholine, N-ethylmorpholine, tris(dimethylaminopropyl)hexahydro-1,3,5-triazine, N,N-dimethylaminoethanol, N′-(3-dimethylaminopropyl)-N,N-diisopropanolamine, dimethylaminoethoxyethanol and bis(dimethylaminoethyl)ether. Amines and amine catalysts of this type are available from Evonik Industries AG under the designation Tegoamin® SMP, Tegoamin® 33 or Tegoamin® ZE 4 for example.

The carboxylic acid metal salt in the compositions of the present invention is preferably a potassium, tin, zinc or bismuth salt and more preferably a tin(II) salt. It is preferable for the compositions of the present invention to contain at least one tin(II) salt of 2-ethylhexanoic acid, ricinoleic acid or 3,5,5-trimethylhexanoic acid. Evonik Industries AG supplies for example a tin ricinoleate catalyst under the designation Kosmos® EF and a tin(II) salt 2-ethylhexanoate catalyst under the designation KOSMOS® 29. Particularly preferred compositions do not include any organotin compounds, such as dibutyltin dilaurate for example.

In the compositions of the present invention, the molar ratio of amines of formula (I) to metal salt of a carboxylic acid is preferably in the range from 1:5 to 5:1 and more preferably in the range from 2.5:1 to 1:2.5.

In addition to the aforementioned components, the composition of the present invention may include further constituents, especially constituents as customarily used in the production of polyurethane foams, for example substances selected from (foam) stabilizers, blowing agents, nucleation additives, cell-refining additives, cell openers, crosslinkers, emulsifiers, flame retardants, surfactants/emulsifiers, antioxidants, antistats, biocides, colour pastes, solid fillers, amine catalysts other than formula (I) and buffers.

The compositions of the present invention, especially when they are reaction mixtures, may further contain one or more polyol components and/or, preferably and, one or more isocyanate components.

Suitable use quantities for the metal salts of carboxylic acids are preferably in the range from 0.02 to 5 pphp (=parts by weight per 100 parts by weight of polyol).

A detailed schedule of said possible further components will be apparent from the following description of the process according to the present invention and of the polyurethane foam according to the present invention:

The compositions of the present invention can be used for producing polyurethane foams. More particularly, the compositions of the present invention can be used in the process which the present invention provides for producing polyurethane foams. The compositions of the present invention can be used to produce slabstock foam and moulded foam.

The process which the present invention provides for producing a polyurethane foam, especially a flexible polyurethane foam, by reacting one or more polyol components with one or more isocyanate components using a metal salt of a carboxylic acid and an amine is characterized in that the amine used is at least one amine of formula (I) as defined above. The amine(s) used of formula (I) are preferably the amines mentioned above as preferred, especially those of formula (IIa) or (IIb) or mixtures thereof. The PU foam is preferably produced by foaming up a mixture containing at least one amine of formula (I), at least one metal catalyst, at least one blowing agent, at least one isocyanate component and at least one polyol component.

Preferably, the process of the present invention utilizes a composition of the present invention, as described above, as reaction mixture; that is, in other words, a composition according to the present invention is present as reaction mixture in the process of the present invention.

To avoid any possible reaction between amine of formula (I) and metal salts of carboxylic acids, it may be preferable to store these components separately from each or one another and to feed them to the reaction mixture at the same time or in succession.

In addition to the amines of formula (I) or the composition of the present invention, as described above, there can further be used one or more substances usable in the production of polyurethane foams and selected from blowing agents, prepolymers, (foam) stabilizers, nucleation aids, cell-refining additives, cell openers, crosslinkers, emulsifiers, flame retardants, surfactants/emulsifiers, antioxidants, viscosity reducers/improvers, UV stabilizers, antistats, biocides, colour pastes, solid fillers, amines/amine catalysts other than formula (I) and buffers.

It may be advantageous for the composition of the present invention, or the reaction mixture, to contain one or more solvents, preferably selected from glycols, alkoxylates or oils of synthetic and/or natural origin.

It will be readily understood that a person skilled in the art seeking to obtain a particular type of flexible polyurethane foam, i.e. a hot-cure, a cold-cure or an ester-type flexible polyurethane foam will choose the particular substances needed for this, e.g. isocyanate, polyol, prepolymer, stabilizers, surfactant/emulsifier, etc. according to the circumstances.

Following is a list of property rights describing suitable components and processes for producing the different types of polyurethane foam, especially types of flexible polyurethane foam, i.e. hot-cure, cold-cure and also ester-type flexible polyurethane foams, which are each fully incorporated herein by reference:

EP 0152878 A1; EP 0409035 A2; DE 102005050473 A1; DE 19629161 A1; DE 3508292 A1; DE 4444898 A1; EP 1061095 A1; EP 0532939 B1; EP 0867464 B1; EP 1683831 A1; DE 102007046860 A1.

Further particulars regarding the starting, catalyst, auxiliary and adjunct materials used are found for example in Kunststoff-Handbuch, Volume 7, Polyurethane, Carl-Hanser-Verlag Munich, 1^{st} edition, 1966, 2^{nd} edition, 1983 and 3^{rd} edition, 1993.

The compounds, components and additives hereinbelow are merely mentioned by way of example and can be replaced by other substances known to a person skilled in the art.

Known blowing agents can be used. There are chemical blowing agents and physical blowing agents. Chemical blowing agents include water, the reaction of which with isocyanate groups leads to the formation of CO₂. The apparent density of the foam can be controlled via the quantity of water added, in which case the preferred use quantities of water are between 0.5 and 7.5 parts, based on 100.0 parts of polyol. Physical blowing agents can also be used as an alternative and/or in addition, examples being carbon dioxide, acetone, hydrocarbons, such as n-, iso- or cyclopentane, cyclohexane, halogenated hydrocarbons, such as methylene chloride, tetrafluoroethane, pentafluoropropane, heptafluoropropane, pentafluorobutane, hexafluorobutane and/or dichloromonofluoroethane. The quantity of physical blowing agent is preferably in the range from 1 to 20 parts by weight and especially from 1 to 15 parts by weight, the quantity of water is preferably in the range from 0.5 to 10 parts by weight and especially from 1 to 5 parts by weight. Carbon dioxide is preferred among the physical blowing agents and is preferably used combined with water as chemical blowing agent.

The blowing agents used are preferably water, n-, iso- or cyclopentane, cyclohexane, methylene chloride, tetrafluoroethane, pentafluoropropane, heptafluoropropane, pentafluorobutane, hexafluorobutane and/or dichloromonofluoroethane, acetone or carbon dioxide.

The water can be added to the reaction mixture directly or, alternatively, can be added to the reaction mixture with one of the reactants, for example the polyol component, as a secondary component thereof.

In addition to or in place of physical blowing agents with or without water, other chemical blowing agents reacting with isocyanates to evolve a gas can also be used, formic acid for example.

As isocyanates or isocyanate component there can be used organic isocyanate compounds that contain two or more isocyanate groups. The aliphatic, cycloaliphatic, araliphatic and preferably aromatic polyfunctional isocyanates known per se are possible in general. Particular preference is given to using isocyanates at from 60 to 140 mol % relative to the sum total of isocyanate-consuming components.

Specific examples are: alkylene diisocyanates having 4 to 12 carbon atoms in the alkylene moiety, e.g. 1,12-dodecane diisocyanate, 2-ethyltetramethylene 1,4-diisocyanate, 2-methylpentamethylene 1,5-diisocyanate, 1,4-tetramethylene diisocyanate and preferably 1,6-hexamethylene diisocyanate, cycloaliphatic diisocyanates, e.g. cyclohexane 1,3- and 1,4-diisocyanates and also any desired mixtures of these isomers, 1-isocyanato-3,3,5-trimethyl-5-isocyanatomethylcyclohexane (IPDI), 2,4- and 2,6-hexahydrotolylene diisocyanates and also the corresponding isomeric mixtures, 4,4′-, 2,2′- and 2,4′-dicyclohexylmethane diisocyanates and also the corresponding isomeric mixtures, and preferably aromatic di- and polyisocyanates, for example 2,4- and 2,6-tolylene diisocyanates and the corresponding isomeric mixtures, 4,4′-, 2,4′- and 2,2′-diphenylmethane diisocyanates and the corresponding isomeric mixtures, mixtures of 4,4′- and 2,2′-diphenylmethane diisocyanates, polyphenylpolymethylene polyisocyanates, mixtures of 4,4′-, 2,4′- and 2,2′-diphenylmethane diisocyanates and polyphenylpolymethylene polyisocyanates (crude MDI) and mixtures of crude MDI and tolylene diisocyanates. Organic di- and polyisocyanates can be used individually or in the form of their mixtures.

It is also possible to use isocyanates modified by the incorporation of urethane, uretdione, isocyanurate, allophanate and other groups, and are known as modified isocyanates.

Organic polyisocyanates will prove particularly advantageous and therefore are used with preference:

tolylene diisocyanate, mixtures of diphenylmethane diisocyanate isomers, mixtures of diphenylmethane diisocyanate and polyphenylpolymethyl polyisocyanate or tolylene diisocyanate with diphenylmethane diisocyanate and/or polyphenylpolymethyl polyisocyanate or so-called prepolymers.

TDI (2,4- and 2,6-tolylene diisocyanate isomeric mixture) can be used as well as MDI (4,4′-diphenylmethane diisocyanate). Crude MDI or polymeric MDI in addition to the 4,4′-isomer also contains the 2,4′- and 2,2′-isomers as well as higher-nuclear products. Pure MDI is the appellation for binuclear products comprising predominantly 2,4′- and 4,4′-isomer mixtures and/or prepolymers thereof. Further suitable isocyanates are recited in the patent documents DE 444898 and EP 1095968, which are each fully incorporated herein by reference.

Useful polyol components include any polyols/compounds having two or more isocyanate-reactive hydrogen atoms. They may be polyether polyols, polyester polyols or natural oil based polyols, which typically bear from 2 to 6 OH groups per molecule and may contain heteroatoms such as nitrogen, phosphorus or halogens as well as carbon, hydrogen and oxygen; the use of polyether polyols is preferred. Polyols of this type are obtainable by known methods, for example by anionic polymerization of alkylene oxides in the presence of alkali metal hydroxides or alkoxides as catalysts and in the presence of at least one starter molecule containing 2 to 3 reactive hydrogen atoms in bonded form, or by cationic polymerization of alkylene oxides in the presence of Lewis acids such as, for example, antimony pentachloride or boron fluoride etherate, or by double metal cyanide catalysis. Suitable alkylene oxides contain 2 to 4 carbon atoms in the alkylene moiety. Examples are tetrahydrofuran, 1,3-propylene oxide, 1,2-butylene oxide and 2,3-butylene oxide; preference is given to using ethylene oxide and/or 1,2-propylene oxide. Alkylene oxides can be used individually, alternatingly in succession or as mixtures. Useful starter molecules include water or 2- and 3-hydric alcohols, such as ethylene glycol, 1,2-propanediol, 1,3-propanediol, diethylene glycol, dipropylene glycol, glycerol, trimethylolpropane and so on. Useful starters further include polyfunctional polyols such as, for example, sugars. Polyether polyols, preferably polyoxypropylene-polyoxyethylene polyols, preferably have a functionality of 2 to 8 and number-averaged molecular weights in the range from 500 to 8000, preferably 800 to 4500. Further polyols are known to a person skilled in the art and are discernible for example from EP-A-0 380 993 or U.S. Pat. No. 3,346,557, which are each fully incorporated herein by reference.

Moulded and high-resilience flexible foams are preferably produced using two- and/or three-functional polyether alcohols having primary hydroxyl groups, preferably above 50 mol % of primary hydroxyl groups based on total hydroxyl groups, especially those having an ethylene oxide block at the end of the chain, or those based on ethylene oxide only.

Slabstock flexible foams are preferably produced using two- and/or three-functional polyether alcohols having secondary hydroxyl groups, preferably above 90 mol % based on total hydroxyl groups, especially those having a propylene oxide block or statistical propylene oxide and ethylene oxide block at the end of the chain, or those based on propylene oxide blocks only.

A further class of polyols are obtained as prepolymers by reaction of polyol with isocyanate in a molar ratio ranging from 100:1 to 5:1 and preferably from 50:1 to 10:1. Prepolymers of this type are preferably used in the form of a solution in a polyol, preferably the polyol which corresponds to the polyol used for preparing the prepolymers.

Yet a further class of polyols are known as the filled polyols (polymer polyols). They contain solid organic fillers up to a solids content of 40 wt % or more in disperse form. Those used include:

SAN polyols: these are highly reactive polyols which contain a copolymer amount based on styrene/acrylonitrile (SAN) in dispersed form.

PHD polyols: these are highly reactive polyols which likewise contain polyurea in dispersed form.

PIPA polyols: these are highly reactive polyols which contain a polyurethane, formed for example by in situ reaction of an isocyanate with an alkanolamine in a conventional polyol, in dispersed form.

The solids content, which is preferably between 5 and 40 wt %, based on the polyol, depending on the application, is responsible for improved cell opening, so the polyol becomes foamable in a controlled fashion, in particular with TDI, and no shrinkage of the foam occurs. The solid thus acts as an essential processing aid. A further function is to control the hardness via the solids content, since higher solids contents confer a higher hardness on the foam.

The formulations with solids-containing polyols are distinctly less self-stable and therefore tend to require physical stabilization in addition to the chemical stabilization due to the crosslinking reaction.

Depending on the solids content of the polyols, these are used either alone or in admixture with the abovementioned unfilled polyols.

Useful polyols of natural origin include any NOPs known in the prior art. Polyols used being of natural origin are preferably based on soybean-based oils, castor oil or palm oil, which can each be subsequently ethoxylated or else left untreated.

Surfactants used in the process for producing polyurethane foams, especially flexible polyurethane foams, in the manner of the present invention are preferably selected from the group comprising anionic surfactants, cationic surfactants, nonionic surfactants and/or amphoteric surfactants.

Useful surfactants for the purposes of the present invention also include polymeric emulsifiers, such as polyalkyl polyoxyalkyl polyacrylates, polyvinylpyrrolidones or polyvinyl acetates. It is similarly possible for the surfactants/emulsifiers used to be prepolymers obtained by reaction of small amounts of isocyanates with polyols (so-called oligourethanes), and which are preferably in the form of a solution in polyols.

Useful biocides include commercially available products, such as chlorophene, benzisothiazolinone, hexahydro-1,3,5-tris(hydroxyethyl-s-triazine), chloromethyl-isothiazolinone, methylisothiazolinone or 1,6-dihydroxy-2,5-dioxohexane, which are known by the trade names of BIT 10, Nipacide BCP, Acticide MBS, Nipacide BK, Nipacide CI, Nipacide FC.

The designation crosslinker is given to preferably low molecular weight (MW<500 g/mol), isocyanate-reactive polyfunctional compounds. Hydroxyl- or amine-terminated substances, such as glycerol, triethanolamine (TEOA), diethanolamine (DEOA) and trimethylolpropane, are suitable for example. Use concentration is typically between 0.5 and 5 parts, based on 100.0 parts (by mass) of polyol depending on the formulation, but can also differ from that. When crude MDI is used in mould foaming, it likewise performs a crosslinking function. As the amount of crude MDI increases, therefore, the level of low molecular weight crosslinkers can be reduced correspondingly.

Useful (foam) stabilizers include any stabilizers known from the prior art. Preference is given to using foam stabilizers based on polydialkylsiloxane-polyoxyalkylene copolymers as generally/commonly used in production of urethane foams. These compounds preferably have a construction wherein, for example, a long-chain copolymer formed from ethylene oxide and propylene oxide is linked to a polydimethylsiloxane moiety. The linkage between the polydialkylsiloxane and the polyether moiety can take the form of an SiC linkage or of an Si—O—C bond. Structurally, the polyether or the different polyethers can attach terminally or laterally to the polydialkylsiloxane. The alkyl radical or the various alkyl radicals may be aliphatic, cycloaliphatic or aromatic. Methyl groups are very particularly advantageous. The polydialkylsiloxane may be linear or else contain branching points. Suitable stabilizers, especially foam stabilizers are described inter alia in U.S. Pat. Nos. 2,834,748; 2,917,480 and also in U.S. Pat. No. 3,629,308. Suitable stabilizers are available from Evonik Industries AG under the trade name TEGOSTAB®.

The process of the present invention can in principle be carried out as any conventional process for producing PU foams, for example paste processes, homogenization via high-pressure homogenizer, stirred processes, etc., as also described in DE 3024870.

All components other than the polyols and isocyanates are often mixed into an activator solution before foaming. This activator solution then preferably contains inter alia the stabilizers (siloxanes), the amines of formula (I), optionally an amine catalyst that does not conform to formula (I), the blowing agent, for example water, and also, possibly, further additives, such as flameproofing, colour, biocides, etc., depending on the recipe of the flexible polyurethane foam.

The activator solution may additionally contain any customary admixtures known in the prior art for activator solutions. The admixtures may be selected from the group comprising flame retardants, UV stabilizers, dyes, biocides, pigments, cell openers, crosslinkers and the like.

A polyurethane foam, preferably a flexible polyurethane foam, is preferably produced by reacting a mixture of polyol, polyfunctional isocyanate, amine of formula (I), optionally amine catalyst comprising an amine that does not come within formula (I), and metal salt of a carboxylic acid, and also, optionally, stabilizer, blowing agent, preferably water to form CO₂, and, if necessary, a mixture of physical blowing agents, optionally with addition of flame retardants, UV stabilizers, colour pastes, biocides, fillers, crosslinkers or other customary processing aids. The polyurethane foam according to the present invention is produced according to the present invention by using an amine of formula (I) in addition to or in lieu of amine catalysts and/or organic potassium, zinc and/or tin compounds or other metal-containing catalysts.

Any conventional process for producing PU foams, in particular flexible polyurethane foams, can be used. The foaming process can for instance take place in batch or continuous systems both horizontally and vertically. Similarly, the formulations used according to the present invention can be used for CO₂ technology. The use in low-pressure machines and high-pressure machines is possible, in which case the compositions can not only be metered directly into the mixing chamber but also be admixed upstream of the mixing chamber to a component thereafter passing into the mixing chamber. The admixing can also take place in the raw-material tank.

The polyurethane foam of the present invention, obtained using a carboxylic acid salt and an amine, is notable in that the foam has a carboxylic acid evolution, preferably a 2-ethylhexanoic acid evolution of ≧0 μg/m³ and ≦5 μg/m³, preferably ≦1 μg/m³ and more preferably ≦0.1 μg/m³, as determined by the DIN 13419-1 test chamber method, 24 hours after test chamber loading, and an amine evolution of ≧0 μg/g to ≦20 μg/g, preferably ≦10 μg/g and more preferably ≦5 μg/g, corresponding to the Daimler-Chrysler test method BP VWT709 VOC determination, 30 minutes at 90° C. The polyurethane foam of the present invention is preferably obtained using an amine conforming to formula (I). The polyurethane foam of the present invention is more preferably obtainable using the process of the present invention or using a composition of the present invention.

The polyurethane foam of the present invention may be a flexible PU foam based on an ether or an ester polyol for example, a PU cold-cure foam, frequently also known as high-resilience (HR) foam or a rigid PU foam. The PU foam of the present invention is preferably a flexible polyurethane foam. The flexible polyurethane foam according to the present invention or obtained according to the present invention is more preferably an open-cell flexible polyurethane foam. Open-cell foams are foams having an air permeability in mm of alcohol column (determined as described in the examples hereinbelow) of not more than 30.

The polyurethane foam of the present invention provides access to articles of manufacture which contain this polyurethane foam or consist of it. Possible articles of this type include, for example, furniture upholstery, refrigerator insulation, sprayable foams, metal-composite elements for (building) insulation, mattresses or auto seats.

The subject-matter of the present invention will now be more particularly elucidated with reference to examples without the subject-matter of the invention being supposed to be restricted to these exemplary embodiments.

### EXAMPLES

Performance Tests

Physical Properties of Flexible Polyurethane Foams

The flexible polyurethane foams obtained were assessed according to the following physical properties:
a) Foam settling at the end of full-rise time: Settling or conversely post-rise is obtained from the difference in foam height after direct blow-off and after 3 min after blow-off of the foam. Foam height here is measured using a needle secured to a centimetre scale, on the peak in the middle of the foam top surface. A negative value here describes the settling of the foam after the blow-off, while a positive value correspondingly describes the post-rise of the foam.
b) Density: Determined as described in ASTM D 3574-08 under Test A by measuring the core density.
c) The air permeability of the foam was measured as back pressure. The measured back pressure was reported in mm of ethanol column, with the lower values characterizing the more open foam. The values were measured in the range from 0 to 300 mm.
d) Compression load deflection CLD, 40% to DIN EN ISO 3386-1.

Measurement of Emissions (VOC Content) by the Daimler-Chrysler Test Method

Emission was determined in line with Daimler-Chrysler test method PB VWT 709. The procedure for performing thermal desorption with subsequent coupled gas chromatography/mass spectrometry (GC/MS) is described below.
a) Measurement technique: Thermal desorption was performed using a “TDS2” thermal desorber with sample changer from Gerstel, Mulheim, combined with a Hewlett Packard HP6890/HP5973 GC/MSD system.
b) Measurement conditions are reported in Tables 1 and 2.

TABLE 1
Thermal desorption measurement parameters

| | |
|---|---|
| Thermal desorption | Gerstel TDS2 |
| Desorption temperature | 90° C. |
| Desorption time | 30 min |
| Flow | 60 ml/min |
| Transfer line | 280° C. |
| Cryofocusing | HP 6890 PTV |
| Liner | Glass vaporizer tube with |
| | silanized glass wool |
| Temperature | −150° C. |

TABLE 2
Gas chromatography/mass spectrometry measurement parameters

| | |
|---|---|
| GC | Capillary GC HP 6890 |
| Injector | PTV Split 1:50 |
| Temperature programme | −150° C.; 3 min; [symbol] 12° C./s; 280° C. |
| Column | Agilent 19091B-115, Ultra 2, 50 m * |
| | 0.32 mm dF 0.5 μm |
| Flow | 1 ml/min const. flow |
| Temperature programme | 50° C.; 5 min; [symbol] 3° C./min; 92° C.; |
| | [symbol] 5° C./min; 160° C.; [symbol] 10° C./min; 280° C., |
| | 20 min |
| Detector | HP MSD 5973 |
| Mode | Scan 29-350 amu 2.3 scans/sec |
| Evaluation | Evaluation of total ion current |
| | chromatogram by calculation as toluene |
| | equivalent |

c) Calibration
For calibration, 1 μl of a mixture of toluene and hexadecane in pentane (each 0.6 mg/ml) was introduced into a cleaned adsorption tube packed with Tenax®TA (mesh 35/60) and measured (desorption 5 min; 280° C.).
d) Sample preparation
   10 mg of foam in three part samples were introduced into a thermal desorption tube. Care was taken to ensure that the foam is not compressed.

Determination of Acid Emission by the So-Called Test Chamber Test:

The acid emission from the foams obtained was determined at room temperature in line with the DIN method DIN 13419-1. Sampling took place after 24 hours. For this, 2 litres of the test chamber atmosphere were passed at a flow rate of 100 ml/min through an adsorption tube packed with Tenax®TA (mesh 35/60). The procedure of thermal desorption with subsequent coupled gas chromatography/mass spectrometry (GC/MS) is described below.

Tenax®TA is a porous polymeric resin based on 2,6-diphenylene oxide and is obtainable, for example, from Scientific Instrument Services, 1027 Old York Rd., Ringoes, N.J. 08551.
e) Measurement technique
   Thermal desorption was performed with a “TDS2” thermal desorber with sample changer from Gerstel, Mülheim, combined with a Hewlett Packard HP6890/HP5973 GC/MSD system.
f) Measurement conditions are reported in Tables 3 and 4.

TABLE 3
Thermal desorption measurement parameters

| | |
|---|---|
| Thermal desorption | Gerstel TDS2 |
| Desorption temperature | 280° C. |
| Desorption time | 5 min |
| Flow | 60 ml/min |
| Transfer line | 280° C. |
| Cryofocusing | HP 6890 PTV |
| Liner | Glass vaporizer tube with |
| | silanized glass wool |
| Temperature | −150° C. |

TABLE 4
Gas chromatography/mass spectrometry measurement parameters

| | |
|---|---|
| GC | Capillary GC HP 6890 |
| Temperature programme | −150° C.; 3 min; [symbol] 12° C./s; 280° C. |
| Column | Agilent 19091B-115, Ultra 2, 50 m * |
| | 0.32 mm dF 0.5 μm |
| Flow | 1 ml/min const. flow |
| Temperature programme | 50° C.; 5 min; [symbol] 3° C./min; 92° C.; |
| | [symbol] 5° C./min; 160° C.; [symbol] 10° C./min; 280° C., |
| | 20 min |
| Detector | HP MSD 5973 |
| Evaluation | Evaluation of total ion current |
| | chromatogram by calculation as toluene |
| | equivalent |

g) Calibration
   For calibration, 1 μl of a mixture of toluene and hexadecane in pentane (each 0.6 mg/ml) was introduced into a cleaned adsorption tube packed with Tenax®TA (mesh 35/60) and measured (desorption 5 min; 280° C.).

### Example 1

### Production of Flexible Polyurethane Foams

Foaming was done using 300 g of polyol; the other constituents of a formulation were appropriately converted arithmetically in that, for example, 1.0 part of a component is to be understood as meaning 1 g thereof per 100 g of polyol.

Foaming was initiated by mixing the polyol, water, the amine of formula (I), tin salt and silicone stabilizer thoroughly under agitation. The isocyanate was added and the mixture was stirred at 3000 rpm for 7 seconds and poured into a paper-lined wooden box (base area 27 cm×27 cm). The foamed material produced was subjected to the performance tests described hereinbelow.

The behaviour of various amines was mutually compared in a recipe based on 3.0 parts of water. The full-rise time profiles of the foams were recorded to be able to compare the catalytic activity. The emission values of the foams were also compared. The following amines were compared against each other: triethylenediamine, 33% solution in dipropylene glycol (TEGOAMIN® 33, obtainable from Evonik Industries), bis(2-dimethylaminoethyl ether) 70% strength solution in dipropylene glycol (TEGOAMIN® BDE, obtainable from Evonik Industries), N-(3-dimethylaminopropyl)-N,N-diisopropylamine (TEGOAMIN® ZE-1, obtainable from Evonik Industries), pentamethyldiethylenetriamine (PMDETA), N,N,N-trimethyl-N-hydroxyethylbisaminoethyl ether (THBAE) and N,N,N-tetramethyl-N-hydroxyethyl-diethylenetriamine (THDTA). The recipe is reported in Table 5.

TABLE 5
Recipe used in Example 1
Recipe

| | |
|---|---|
| 100 | parts of polyol*¹ |
| 3.0 | parts of water |
| 0.6 | part of TEGOSTAB ®B 8110 foam stabilizer*² |
| 0.15 | part of catalyst*³ |
| 0.15 | part of amine |
| 40.1 | parts of isocyanate (tolylene diisocyanate T80) |
| | (80% 2,4-isomer, 20% 2,6-isomer) |

*¹= polyether triol of OH number 48.
*²= TEGOSTAB ® products obtainable from Evonik Industries, polysiloxane-polyoxyalkylene block copolymers for use as foam stabilizer in the production of flexible slabstock and moulded polyurethane foams.
*³= KOSMOS ®29, obtainable from Evonik Industries, the tin(II) salt of 2-ethylhexanoic acid.

Foaming results are reported in Table 6.

TABLE 6
Foaming results of Example 1

| | | | | Compression | |
|---|---|---|---|---|---|
| | | | | load deflec- | |
| | | | Porosity | tion CLD40 | |
| Amine | Full-rise | Density | (open-cell | compression | Settling |
| (0.15 part) | time [s] | [kg/m³] | content)* | [kPa] | [cm] |
| TEGOAMIN ® | 150 | 31.2 | 23 | 4.0 | 0.4 |
| 33 | | | | | |
| TEGOAMIN ® | 121 | 30.4 | 11 | 3.4 | 0.3 |
| BDE | | | | | |
| TEGOAMIN ® | 168 | 31.2 | 29 | 3.2 | 0.0 |
| ZE-1 | | | | | |
| THBAE | 135 | 30.7 | 17 | 3.6 | 0.4 |
| PMDETA | 120 | 30.3 | 16 | 3.3 | 0.5 |
| THDTA | 142 | 30.0 | 16 | 3.7 | 0.5 |

*= (back pressure of mm of alcohol column)

### Example 2

### Foaming Results—Emissions

To investigate the influence of amines on foam emissions, a recipe containing a low-emission polyol was selected. Total emissions were measured as well as acid emissions and amine emissions. The recipe used is reported in Table 7.

TABLE 7
Recipe used in Example 2
Recipe

| | |
|---|---|
| 100 | parts of polyol*⁴ |
| 3.0 | parts of water |
| 0.8 | part of foam stabilizer*² (TEGOSTAB ®B 8228*²) |
| 0.2 | catalyst*³ (KOSMOS ®29*³) |
| 0.25 | amine |
| 39.6 | parts of isocyanate (tolylene diisocyanate T80) |
| | (80% 2,4-isomer, 20% 2,6-isomer) |

*²= TEGOSTAB ® products obtainable from Evonik Industries, polysiloxane-polyoxyalkylene block copolymers for use as foam stabilizer in the production of flexible slabstock and moulded polyurethane foams.
*³= KOSMOS ®29, obtainable from Evonik Industries, the tin(II) salt of 2-ethylhexanoic acid.
*⁴= low-emission polyether triol of OH number 56

The emission characteristics of the foams described above were investigated in conformity with Daimler-Chrysler test method BP VWT 709 VOC determination (30 min at 90° C.). The results are reported in Table 8.

TABLE 8
Results regarding Example 2

| | VOC content | | | | | |
|---|---|---|---|---|---|---|
| Amine catalyst | VOC (total) | | VOC (amine) | | VOC (acid) | |
| TEGOAMIN ® 33 | 740 | μg/g | 141 | μg/g | 634 | μg/g |
| TEGOAMIN ® BDE | 980 | μg/g | 466 | μg/g | 509 | μg/g |
| TEGOAMIN ® ZE-1 | 420 | μg/g | not detectable | | 407 | μg/g |
| THBAE | 530 | μg/g | 7 | μg/g | 521 | μg/g |
| PMDETA | 1480 | μg/g | 1028 | μg/g | 424 | μg/g |

| | | | | |
|---|---|---|---|---|
| THDTA | <10 | μg/g | not detectable | not detectable |

### Example 3

### Foaming Results—Acid Emissions with Amine Acid Scavenger Blends

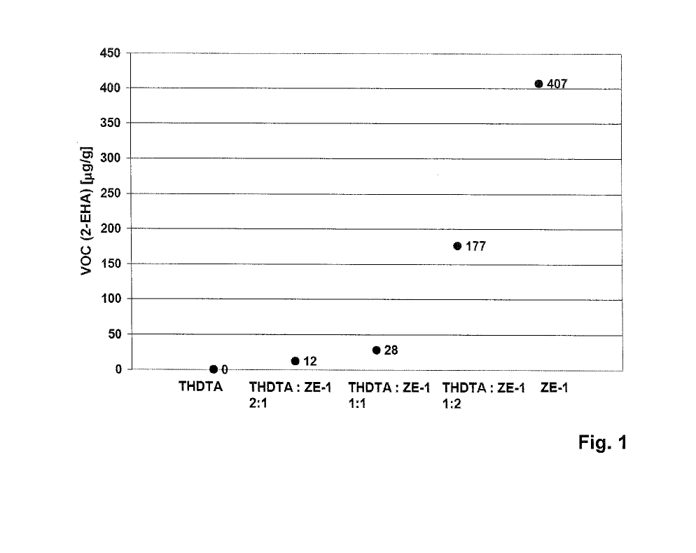

The same recipe was chosen as in Example 2. The catalytically active acid scavenger or amine used was THDTA or mixtures thereof with TEGOAMIN® ZE-1, as reported in Table 9, and VOC emissions were measured. The results obtained are reported hereinbelow in Table 9. The results in Table 9 are also graphed in FIG. 1.

TABLE 9
Amines used and results of Example 3

| Amine catalyst | 2-EHA emissions | |
|---|---|---|
| THDTA | not detectable | |
| THDTA:ZE-1 = 2:1 | 12 | μg/g |
| THDTA:ZE-1 = 1:1 | 28 | μg/g |
| THDTA:ZE-1 = 1:2 | 177 | μg/g |
| ZE-1 | 407 | μg/g |

It is clearly apparent that THDTA acts as an acid scavenger and greatly reduces 2-ethylhexanoic acid emissions even when mixed with amine catalysts that do not act as acid, scavengers.

### Example 4

### Foaming Results—Acid Emissions on Using Various Carboxylic Acid-Based Metal Catalysts

The recipe chosen is similar to that in Example 2 and is reported in Table 10. To check whether the acid scavenger of the present invention also reduces the evolution of acids other than 2-ethylhexanoic acid, KOSMOS® 27 (obtainable from Evonik Industries), the tin(II) salt of 3,5,5-trimethylhexanoic acid, was used as well as KOSMOS® 29. TEGOAMIN® 33 amine (available from Evonik Industries) serves as reference. It is known from the above examples that this amine is not conducive to reducing emissions. The results are reported in Table 11.

TABLE 10
Recipe used in Example 4
Recipe

| | |
|---|---|
| 100 | parts of polyof*⁴ |
| 3.0 | parts of water |
| 0.8 | part of TEGOSTAB ®B 8228 foam stabilizer*² |
| X | part of KOSMOS ® catalyst *⁵ |
| 0.25 | part of amine |
| 39.6 | parts of isocyanate (tolylene diisocyanate T80) |
| | (80% 2,4-isomer, 20% 2,6-isomer) |

*²= TEGOSTAB ® products obtainable from Evonik Industries, polysiloxane-polyoxyalkylene block copolymers for use as foam stabilizer in the production of flexible slabstock and moulded polyurethane foams.
*⁴= low-emission polyether triol of OH number 56
*⁵ = 0.2 part of KOSMOS ®29 available from Evonik Industries, the tin(II) salt of 2-ethylhexanoic acid. 0.22 part of KOSMOS ®27 available from Evonik Industries, the tin(II) salt of 3,5,5-trimethylhexanoic acid.

TABLE 11
Results of Example 4.

| Amine catalyst | Catalyst*⁵ | Acid emissions |
|---|---|---|
| THDTA | KOSMOS ® 29 | not detectable |
| THDTA | KOSMOS ® 27 | not detectable |
| TEGOAMIN ® 33 | KOSMOS ® 29 | 568 μg/g |
| TEGOAMIN ® 33 | KOSMOS ® 27 | 408 μg/g |

The results are unambiguous in showing that using the acid scavenger THDTA also serves to reduce the emissions of carboxylic acids other than 2-ethylhexanoic acid.

1. A composition comprising:
at least one metal salt of a carboxylic acid and one or more amines of formula (I)
R⁴R¹₂N—(CH₂)ₓ—N(R³)—(CH₂)_{y}—NR¹R² (I)
where R¹, in each occurrence is the same or different, and is a hydrocarbon radical of 1 to 10 carbon atoms,
R², R³ and R⁴ are each R¹ or a —(Z)_{z}—OH radical and are the same or different in each occurrence, where
Z is CH₂ or CHR′ where R′=hydrocarbon radical of 1 to 10 carbon atoms, and is the same or different in each occurrence,
z=1 to 10,
x=1 to 10,
Y=1 to 10,
with the proviso that at least one of R², R³ and R⁴ is a —(Z)_{z}—OH radical.

2. The composition according to claim 1, wherein said at least one amine of formula (I) includes at least one amine of formulae (IIa) and/or (IIb) or of formulae (IIc1), (IIc2), (IId1) and/or (IId2) 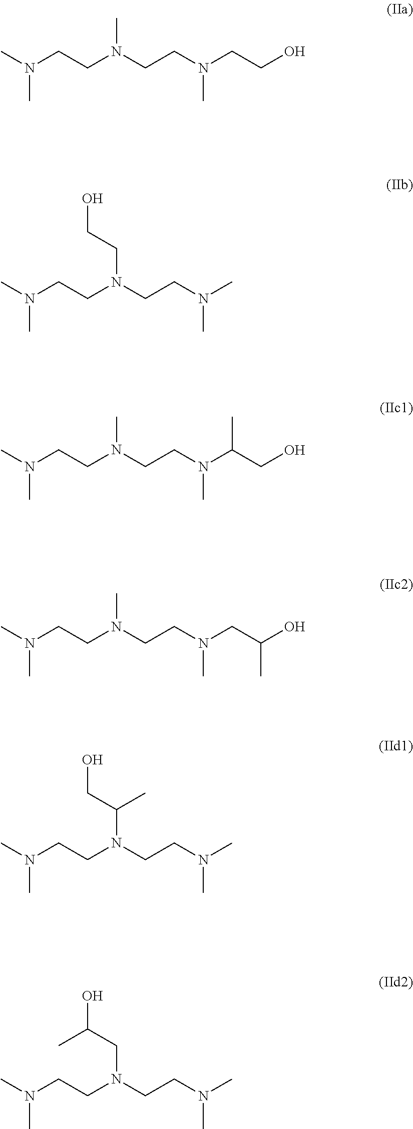
.

3. The composition according to claim 2, wherein a mixture of amines of formulae (IIa) and (IIb) or of amines of formulae (IIc1), (IIc2), (IId1) and/or (IId2) is present.

4. The composition according to claim 1, further comprising amines which do not conform to formula (I) and which catalyze at least one of a gel reaction, a blowing reaction and a di- or trimerization of isocyanate.

5. The composition according to claim 1, wherein said at least one metal salt of said carboxylic acid is at least one tin(II) salt of 2-ethylhexanoic acid, ricinoleic acid or 3,5,5-trimethylhexanoic acid.

6. The composition according to claim 1, wherein said at least one or more amines of formula (I) and said at least one metal salt of said carboxylic acid are present in a molar ratio of said at least one or more amines of formula (I) to said at least one metal salt of said carboxylic acid of from 5:1 to 1:5.

7. A process for producing a polyurethane foam, said process comprising:
reacting one or more polyol components with one or more isocyanate components in the presence of a metal salt of a carboxylic acid and an amine, wherein the amine comprises at least one amine of formula (I)
R⁴R¹₂N—(CH₂)ₓ—N(R³)—(CH₂)_{y}—NR¹R² (I)
where R¹, in each occurrence is the same or different, and is a hydrocarbon radical of 1 to 10 carbon atoms,
R², R³ and R⁴ are each R¹ or a —(Z)_{z}—OH radical and are the same or different in each occurrence, where
Z is CH₂ or CHR′ where R′=hydrocarbon radical of 1 to 10 carbon atoms, and is the same or different in each occurrence,
z=1 to 10,
x=1 to 10,
Y=1 to 10,
with the proviso that at least one of R², R³ and R⁴ is a —(Z)_{z}—OH radical.

8. The process according to claim 7, wherein said metal salt of said carboxylic acid and said amine are present as a reaction mixture.

9. The process according to claim 6, wherein said reacting further includes the presence of one or more substances usable in the production of polyurethane foams and selected from foamstabilizers, nucleation additives, cell-refining additives, cell openers, crosslinkers, emulsifiers, flame retardants, surfactants/emulsifiers, antioxidants, antistatics, UV stabilizers, viscosity modifiers, biocides, colour pastes, solid fillers, amine catalysts other than formula (I) and buffers.

10. The process according to claim 7, wherein said reacting further includes the presence of a blowing agent, said blowing agent is selected from water, methylene chloride, pentane, alkanes, halogenated alkanes, acetone and carbon dioxide.

11. A polyurethane foam obtained using at least one metal salt of a carboxylic acid and at least one amine, wherein said polyurethane foam has a carboxylic acid emission of ≧0 μg/m³ and ≦5 μg/m³, as determined by the DIN 13419-1 test chamber method, 24 hours after test chamber loading, and an amine emission of ≧0 μg/g to ≦20 μg/g, corresponding to the Daimler-Chrysler test method BP VWT709 VOC determination, 30 minutes at 90° C.

12. The polyurethane foam according to claim 11, wherein said amine comprises at least one amine of formula (I)
R⁴R¹₂N—(CH₂)ₓ—N(R³)—(CH₂)_{y}—NR¹R² (I)
where R¹, in each occurrence is the same or different, and is a hydrocarbon radical of 1 to 10 carbon atoms,
R², R³ and R⁴ are each R¹ or a —(Z)_{z}—OH radical and are the same or different in each occurrence, where
Z is CH₂ or CHR′ where R′=hydrocarbon radical of 1 to 10 carbon atoms, and is the same or different in each occurrence,
z=1 to 10,
x=1 to 10,
Y=1 to 10,
with the proviso that at least one of R², R³ and R⁴ is a —(Z)_{z}—OH radical.

13. (canceled)

14. The polyurethane foam according to 11, wherein said polyurethane foam is a flexible polyurethane foam.

15. An article comprising a polyurethane foam, said polyurethane foam having a carboxylic acid emission of ≧0 μg/m³ and ≦5 μg/m³, as determined by the DIN 13419-1 test chamber method, 24 hours after test chamber loading, and an amine emission of ≧0 μg/g to ≦20 μg/g, corresponding to the Daimler-Chrysler test method BP VWT709 VOC determination, 30 minutes at 90° C.
